(19) United States
(12) Patent Application Publication
(10) Pub. No.: US 2021/0264904 A1
(43) Pub. Date: Aug. 26, 2021

(54) INFORMATION PROCESSING APPARATUS AND INFORMATION PROCESSING METHOD

(71) Applicant: SONY CORPORATION, TOKYO (JP)

(72) Inventor: MOTOKI TSUNOKAWA, TOKYO (JP)

(21) Appl. No.: 17/250,199

(22) PCT Filed: Apr. 11, 2019
(86) PCT No.: PCT/JP2019/015873

§ 371 Date: Dec. 14, 2020

(30) Foreign Application Priority Data
Jun. 21, 2018 (JP) 2018-117595

(51) Int. Cl. G10L 15/18; G10L 15/22

(52) U.S. Cl. CPC G10L 15/1815; G10L 15/22

(57) ABSTRACT

Provided are an information processing apparatus and an information processing method for interpreting a user's utterance. The information processing apparatus includes: a generation unit that generates an utterance intention from a user's utterance, the utterance intention including an intent and a slot; and a determination unit that determines a most appropriate interpretation among a plurality of candidates on the basis of context information at the time of the user's utterance in a case where the generation unit obtains the plurality of candidates for at least one of the intent or the slot. An interpreted matter regarding the intent or the slot and context information to which the interpreted matter is to be applied are stored as interpretation knowledge, and the determination unit determines an interpretation of the utterance intention of the user on the basis of the matching of the context information.

### TECHNICAL FIELD

The technology disclosed in the present specification relates to an information processing apparatus and an information processing method for interpreting a user's utterance.

### BACKGROUND ART

In recent years, with the development of voice recognition technology, machine learning technology, and the like, various electronic devices such as information devices and home appliances have been equipped with a speech function also called a “voice agent”. An electronic device equipped with the voice agent interprets a user's utterance, executes a device operation instructed by voice, and provides voice guidance regarding, for example, notification of the state of the device and explanation as to how to use the device. In addition, an Internet of Things (IoT) device does not include conventional input devices such as a mouse and a keyboard, and a user interface (UI) using voice information rather than character information is dominant.

Here, there is a problem that utterances of people are often ambiguous. For example, the utterance “Play Mike” can be interpreted in several ways as shown in (1) to (3) below.

(1) Play a song of a singer named Mike (intent: music playback, slot: [singer]=Mike)

(2) Play a movie titled Mike (intent: movie playback, slot: [movie title]=Mike)

(3) Play a TV program called Mike that has been recorded (intent: TV program playback, slot: [TV program name]=Mike)

Furthermore, as for the utterance “Tell me about the weather in Osaki”, there are several possible interpretations as shown in (1) to (3) below. This is because there are several places named “Osaki” in Japan.

(1) Osaki Town in Kagoshima (slot: [place]=Osaki Town in Kagoshima)

(2) Osaki City in Miyagi Prefecture (slot: [place]=Osaki City in Miyagi Prefecture)

(3) Osaki in Shinagawa-ku, Tokyo (slot: [place]=Osaki in Shinagawa-ku, Tokyo)

If a system misinterprets a user's ambiguous utterance (or interprets the utterance in a different way from the user's intention) in a service involving voice interaction, a response different from the user's expectation will be returned from the system. There is a possibility that users may become distrustful of the system and even stop using the system if their requests are not met several consecutive times.

For example, an interaction method has been proposed, which includes: a situation language model including a set of vocabularies associated with a plurality of situations; and a switching language model that is a set of vocabularies, in which the intention of a user's utterance is interpreted with reference to the situation language model and the switching language model described above, and in a case where a vocabulary included in the switching language model but not in the current situation language model is found in the user's utterance, there is generated an utterance according to a situation corresponding to the vocabulary, instead of the current situation (see Patent Document 1).

Furthermore, an utterance candidate generation apparatus has been proposed, in which a plurality of modules is provided to generate utterance candidates having different utterance qualities, and modules sequentially generate utterance candidates for a user's utterance in descending order of appropriateness of utterance candidates to be generated by the modules (see Patent Document 2).

### CITATION LIST

### Patent Document

Patent Document 1: Japanese Patent Application Laid-Open No. 2009-36998
Patent Document 2: Japanese Patent Application Laid-Open No. 2014-222402

### SUMMARY OF THE INVENTION

### Problems to be Solved by the Invention

An object of the technology disclosed in the present specification is to provide an information processing apparatus and an information processing method that enable a user's ambiguous utterance to be interpreted as correctly as possible.

### Solutions to Problems

The technology disclosed in the present specification has been made in consideration of the above problem, and a first aspect thereof is an information processing apparatus including:

a generation unit that generates an utterance intention from a user's utterance, the utterance intention including an intent and a slot; and

a determination unit that determines a most appropriate interpretation among a plurality of candidates on the basis of context information at a time of the user's utterance in a case where the generation unit obtains the plurality of candidates for at least one of the intent or the slot. Here, the intent is an application or a service, execution of which is requested by the user's utterance, and the slot is attached information to be used when the application or the service is executed. In addition, the context information is information regarding circumstances other than a spoken voice at the time of the user's utterance.

The information processing apparatus according to the first aspect further includes: a collection unit that acquires the context information at the time of the user's utterance; a response unit that responds to the user by voice on the basis of the utterance intention of the user; and a collection unit that collects feedback information from the user on the response from the response unit.

Furthermore, the information processing apparatus according to the first aspect further includes a storage unit that stores, as interpretation knowledge, an interpreted matter regarding the intent or the slot and context information to which the interpreted matter is to be applied, in which the determination unit determines an interpretation of the utterance intention of the user on the basis of interpretation knowledge that matches the context information at the time of the user's utterance.

In addition, a second aspect of the technology disclosed in the present specification is an information processing method including:

a generation step of generating an utterance intention from a user's utterance, the utterance intention including an intent and a slot; and

a determination step of determining a most appropriate interpretation among a plurality of candidates on the basis of context information at a time of the user's utterance in a case where the plurality of candidates is obtained for at least one of the intent or the slot in the generation step.

### Effects of the Invention

According to the technology disclosed in the present specification, it is possible to provide an information processing apparatus and an information processing method that enable a user's ambiguous utterance to be more correctly interpreted by using context information (current circumstances as to when an utterance was made, who made the utterance, and the like) and user feedback information (a reaction from a user to a past system response (for example, whether a request has been met or not).

Note that the effects described in the present specification are merely illustrative, and the effects of the present invention are not limited thereto. Furthermore, the present invention may also achieve additional effects other than the above effects.

Still other objects, features, and advantages of the technology disclosed in the present specification will become apparent from more detailed description based on an embodiment to be described later and the accompanying drawings.

### BRIEF DESCRIPTION OF DRAWINGS

FIG. 1 is a diagram schematically showing a configuration example of an information processing apparatus 100 equipped with a voice agent function.

FIG. 2 is a diagram schematically showing a configuration example of software for causing the information processing apparatus 100 to operate as a voice agent.

FIG. 3 is a diagram showing an example of context information having a hierarchical structure.

FIG. 4 is a diagram showing a processing flow for inputting a user's utterance and making a voice response in the information processing apparatus 100.

FIG. 5 is a diagram showing in detail a process to be performed by an utterance intention understanding function 202.

FIG. 6 is a diagram schematically showing the configuration of an interpretation knowledge database.

FIG. 7 is a diagram schematically showing the configuration of a knowledge acquisition score table.

FIG. 8 is a diagram showing an example of a knowledge acquisition score assigned to each acquisition method.

FIG. 9 is a diagram showing an example of the result of performing a context acquisition process.

FIG. 10 is a diagram for describing a method of abstracting context information.

### MODE FOR CARRYING OUT THE INVENTION

Hereinafter, an embodiment of the technology disclosed in the present specification will be described in detail with reference to the drawings.

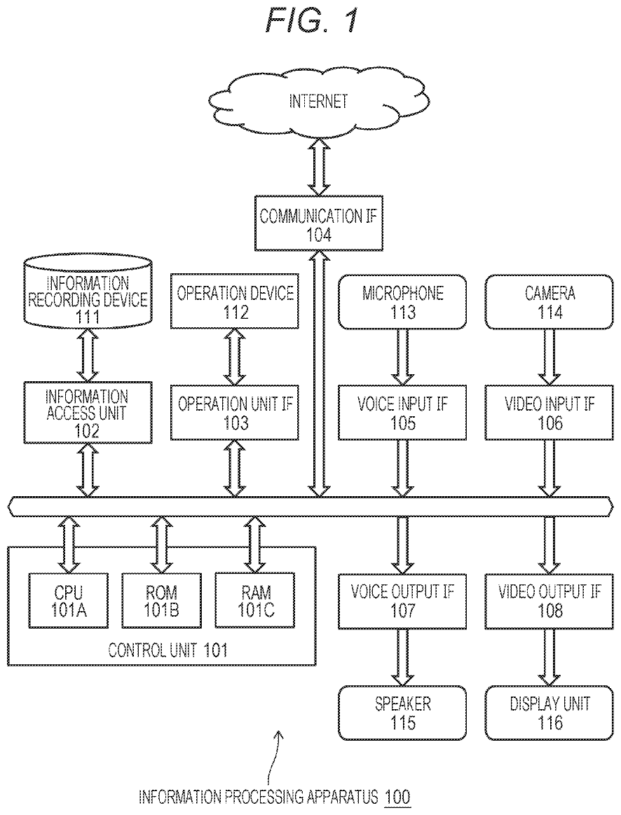

FIG. 1 schematically shows a configuration example of an information processing apparatus 100 equipped with a voice agent function. The information processing apparatus 100 shown in the drawing includes a control unit 101, an information access unit 102, an operation unit interface (IF) 103, a communication interface (IF) 104, a voice input interface (IF) 105, a video input interface (IF) 106, a voice output interface (IF) 107, and a video output interface (IF) 108.

The control unit 101 includes a central processing unit (CPU) 101A, a read only memory (ROM) 101B, and a random access memory (RAM) 101C. The CPU 101A executes various programs loaded into the RAM 101C. As a result, the control unit 101 performs centralized control of the overall operation of the information processing apparatus 100.

The information access unit 102 reads information stored in an information recording device 111 including a hard disk and the like, and loads the information into the RAM 101C in the control unit 101, or writes information to the information recording device 111. Examples of information to be recorded in the information recording device 111 include software programs (operating system, application, and the like) to be executed by the CPU 101A, and data to be used during program execution or to be generated as a result of program execution. These pieces of information are basically handled in the file format.

The operation unit interface 103 performs a process of converting, into input data, a user operation performed on an operation device 112 such as a mouse, a keyboard, or a touch panel and passing the input data to the control unit 101.

The communication interface 104 exchanges data via a network such as the Internet according to a predetermined communication protocol.

The voice input interface 105 performs a process of converting a voice signal picked up by a microphone 113 into input data and passing the input data to the control unit 101. The microphone 113 may be either a monaural microphone or a stereo microphone capable of stereo sound collection.

The video input interface 106 performs a process of taking in a video signal of a moving image or a still image captured by a camera 114 and passing the video signal to the control unit 101. The camera 114 may be a camera with a 90-degree angle of view or an omnidirectional camera with a 360-degree angle of view. Alternatively, the camera 114 may be a stereo camera or a multi-view camera.

The voice output interface 107 performs a process for causing voice data that the control unit 101 has designated as data to be output, to be reproduced and output from a speaker 115. The speaker 115 may be a stereo speaker or a multichannel speaker.

The video output interface 108 performs a process for outputting image data that the control unit 101 has designated as data to be output, to the screen of a display unit 116. The display unit 116 includes a liquid crystal display, an organic EL display, a projector, or the like.

Note that each of the interface devices 103 to 108 is configured according to a predetermined interface standard as needed. Furthermore, the information recording device 111, the operation device 112, the microphone 113, the camera 114, the speaker 115, and the display unit 116 may be components included in the information processing apparatus 100, or may be external devices externally attached to the main body of the information processing apparatus 100.

In addition, the information processing apparatus 100 may be a device dedicated to a voice agent also called “smart speaker”, “AI speaker”, “AI assistant”, or the like, or may be an information terminal such as a smartphone or a tablet terminal in which a voice agent application resides. Alternatively, the information processing apparatus 100 may be an information home appliance, an IoT device, or the like.

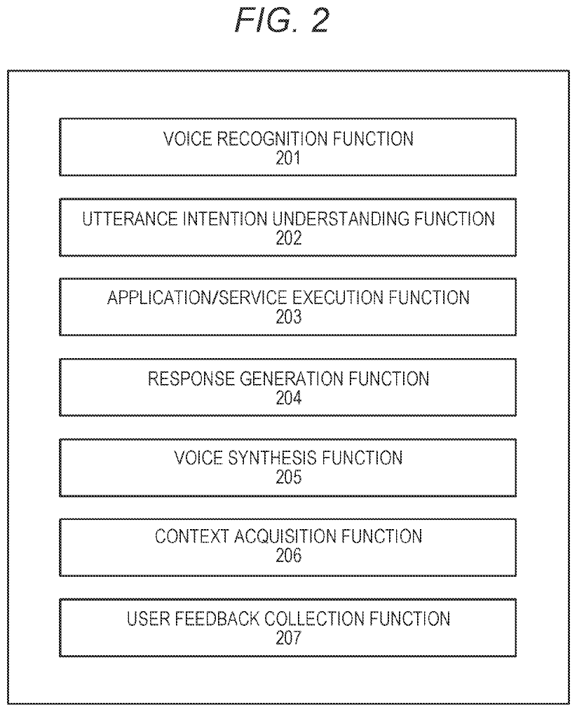

FIG. 2 schematically shows a configuration example of software to be executed by the control unit 101 for causing the information processing apparatus 100 to operate as a voice agent. In the example shown in FIG. 2, software for operating as a voice agent includes a voice recognition function 201, an utterance intention understanding function 202, an application/service execution function 203, a response generation function 204, a voice synthesis function 205, a context acquisition function 206, and a user feedback collection function 207. Each of the functional modules 201 to 207 will be described below.

The voice recognition function 201 is a function of receiving a voice such as a user's inquiry input from the microphone 113 via the voice input interface 105, performing voice recognition, and replacing the voice with text.

The utterance intention understanding function 202 is a function of semantically analyzing a user's utterance and generating an “intention structure”. The intention structure mentioned here includes an intent and a slot. In the present embodiment, the utterance intention understanding function 202 also has the function of performing the most appropriate interpretation (selection of the most appropriate intent and slot) in view of context information acquired by the context acquisition function 206 and user feedback information collected by the user feedback collection function 207 in a case where there are multiple possible intents or multiple possible slots.

The application/service execution function 203 is a function of executing an application or service that matches a user's utterance intention, such as music playback, the checking of the weather, or an order for products.

The response generation function 204 is a function of generating a response sentence to the user's inquiry received by the voice recognition function 201 on the basis of, for example, the result of application or service execution performed by the application/service execution function 203 in accordance with the user's utterance intention.

The voice synthesis function 205 is a function of synthesizing voice from the response sentence (after conversion) generated by the response generation function 204. The voice synthesized by the voice synthesis function 205 is output from the speaker 115 via the voice output interface 107.

The context acquisition function 206 acquires context information regarding circumstances other than a spoken voice when the user utters. Such context information includes the time zone of the user's utterance, the place of utterance, a person nearby (a person who was near the user at the time of utterance), or the current environmental information. Note that the information processing apparatus 100 may be further equipped with a sensor (not shown in FIG. 1) for acquiring context information, or may acquire at least a part of context information from the Internet via the communication interface 104. Examples of the sensor include a clock that measures the current time and a position sensor (GPS sensor or the like) that acquires location information. In addition, a person nearby can be acquired as a result of performing facial recognition on an image of the user and the person nearby captured by the camera 114.

The user feedback collection function 207 is a function of collecting the user's reaction made when the response sentence generated by the response generation function 204 is uttered by the voice synthesis function 205. For example, when the user reacts and makes a new utterance, it is possible to collect the user's reaction on the basis of voice recognition performed by the voice recognition function 201 and the intention structure analyzed by the utterance intention understanding function 202.

The functional modules 201 to 207 described above are software modules that are basically loaded into the RAM 101C and executed by the CPU 101A in the control unit 101. However, at least some of the functional modules can also be provided and executed not in the main body of the information processing apparatus 100 (for example, in the ROM 101B) but through the communication interface 104 in collaboration with agent services built on the cloud. Note that the term “cloud” generally refers to cloud computing. The cloud provides computing services via networks such as the Internet.

The information processing apparatus 100 has a voice agent function of interacting with a user mainly through voice. That is, the information processing apparatus 100 recognizes a user's utterance by the voice recognition function 201, interprets the intention of the user's utterance by the utterance intention understanding function 202, executes an application or service that matches the user's intention by the application/service execution function 203, generates a response sentence based on the execution result by the response generation function 204, and synthesizes a voice from the response sentence by the voice synthesis function 205 to reply to the user.

In order for the information processing apparatus 100 to provide a high-quality interactive service, it is essential to correctly interpret a user's utterance intention. This is because if the utterance intention is misinterpreted, a response different from the user's expectation is returned and thus, the user's request is not met. Users become distrustful of the interactive service and eventually avoid using the service if their requests are not met several consecutive times.

Here, the utterance intention includes an intent and a slot. The intent refers to a user's intention in an utterance. The intent corresponds to an application or service for requesting execution of, for example, music playback, the checking of the weather, or an order for products. Furthermore, the slot refers to attached information necessary for executing the application or service. Examples of the slot include the name of a singer and a song title (in music playback), a place name (in checking the weather), and a product name (in ordering products). Alternatively, it can also be said that a predicate corresponds to the intent and an object corresponds to the slot in an imperative sentence that the user utters to the voice agent.

There may be multiple possible candidates for at least one of the intent or the slot in the user's utterance in some cases. Examples of such cases include a case where there are multiple candidates for the combination of the intent and the slot for the utterance “Play Mike” and a case where there are multiple candidates for the slot for the utterance “Tell me about the weather in Osaki” (as described above). Multiple candidates for the intent or the slot are the main reason for misinterpretation of a user's utterance intention.

Therefore, the information processing apparatus 100 according to the present embodiment is configured to more properly interpret the intention of a user's utterance by the utterance intention understanding function 202 on the basis of the context information acquired by the context acquisition function 206 and the user feedback information collected by the user feedback collection function 207.

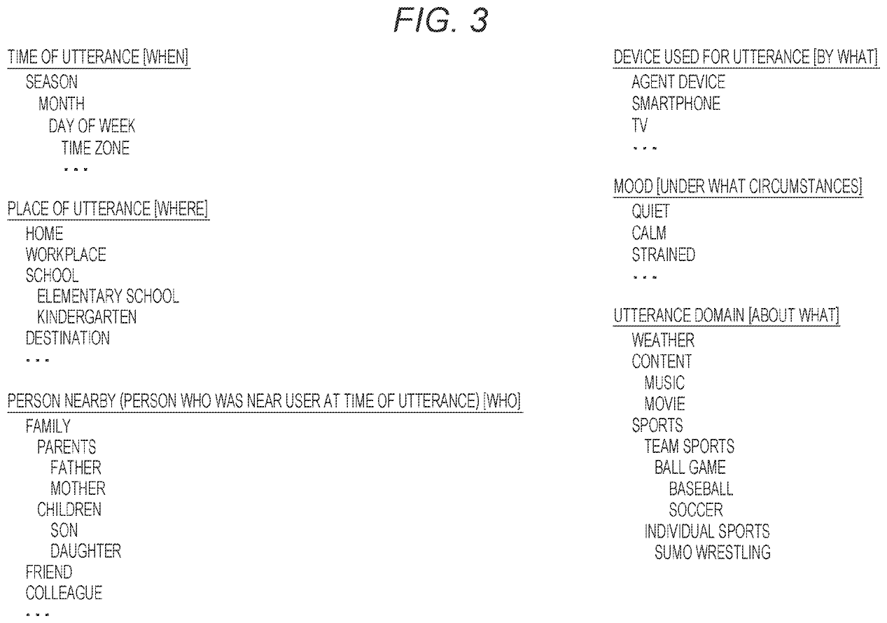

In the present specification, the context information refers to information regarding circumstances other than a spoken voice at the time of a user's utterance. In the present embodiment, the context information is handled in a hierarchical structure. For example, the date and time of an utterance is acquired and stored in a structure including a season, a month, a day of the week, a time zone, and the like. FIG. 3 shows an example of context information having a hierarchical structure. In the example shown in FIG. 3, the context information includes items such as the time of utterance (when), the place of utterance (where), a person nearby (who), a device used for utterance (by what), a mood (under what circumstances), and an utterance domain (about what), and each item is hierarchized. A more abstract concept is placed higher in the hierarchy, and a concept placed lower in the hierarchy is more specific. In FIG. 3, context information regarding the “utterance domain” is not attached to the interpretation knowledge of an intent, but is attached only to the interpretation knowledge of a slot. It is assumed that the information processing apparatus 100 can detect each of these items of the context information by using the environment sensor (described above) or the camera 114, or can acquire each of the items from an external network via the communication interface 104.

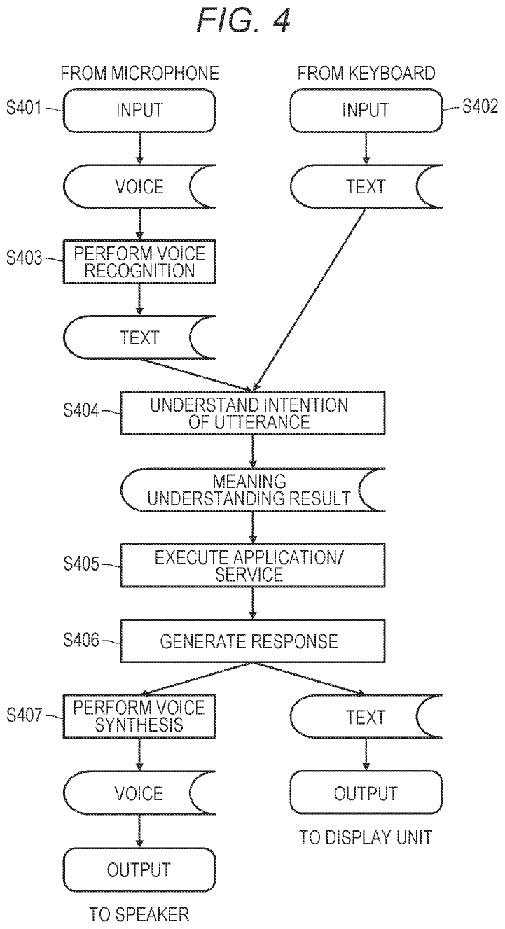

FIG. 4 shows a processing flow for inputting a user's utterance and making a voice response in the information processing apparatus 100.

A user inputs voice data to the information processing apparatus 100 through the microphone 113 (S401). Furthermore, the user inputs text data to the information processing apparatus 100 from the operation device 112 such as a keyboard (S402).

In a case where voice data are input, the voice recognition function 201 performs voice recognition to replace the voice data with text data (S403).

Next, the utterance intention understanding function 202 semantically analyzes the user's utterance on the basis of the input data in text format, and generates an intention structure including a single intent and a single slot (S404).

In the present embodiment, the utterance intention understanding function 202 selects the most appropriate interpretation of the intention of a user on the basis of the context information and the user feedback information in a case where there are multiple candidates for at least one of the intent or the slot and the utterance intention is ambiguous. However, details thereof will be described later.

Next, the application/service execution function 203 executes an application or service that matches the user's intention, such as music playback, the checking of the weather, or an order for products, on the basis of the result of understanding the intention of the user's utterance by the utterance intention understanding function 202 (S405).

Next, the response generation function 204 generates a response sentence to the user's inquiry received by the voice recognition function 201 on the basis of, for example, the result of execution by the application/service execution function 203 (S406).

The response sentence generated by the response generation function 204 is in the form of text data. The response sentence in text format is synthesized to generate voice data by the voice synthesis function 205, and then output as voice from the speaker 115 (S407). Furthermore, the response sentence generated by the response generation function 204 may be output simply as text data or as a composite image including the text data to the screen of the display unit 116.

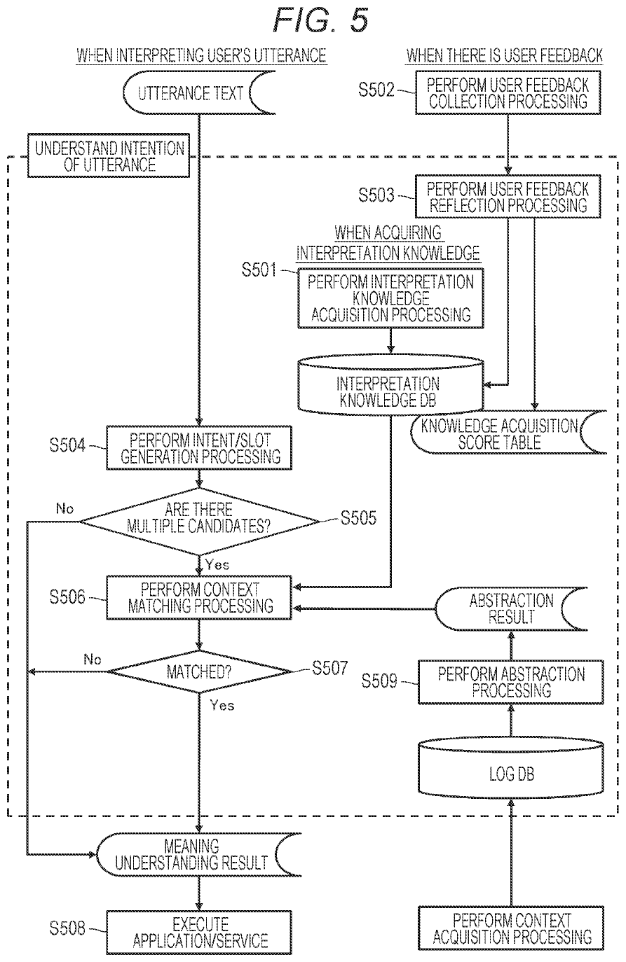

FIG. 5 shows in detail internal processing to be performed by the utterance intention understanding function 202 in the processing flow shown in FIG. 4.

The utterance intention understanding function 202 performs the following three lines of processing: when acquiring interpretation knowledge, when there is user feedback, and when interpreting a user's utterance. The processing of each line will be described below.

When acquiring interpretation knowledge:

When interpretation knowledge is acquired, the utterance intention understanding function 202 performs processing (that is, interpretation knowledge acquisition processing) for associating an interpreted matter thereof with context information acquired at the time of acquisition of the interpretation knowledge, assigning an interpretation score indicating the superiority or inferiority of the interpretation thereto, and storing the interpretation knowledge in an interpretation knowledge database (S501).

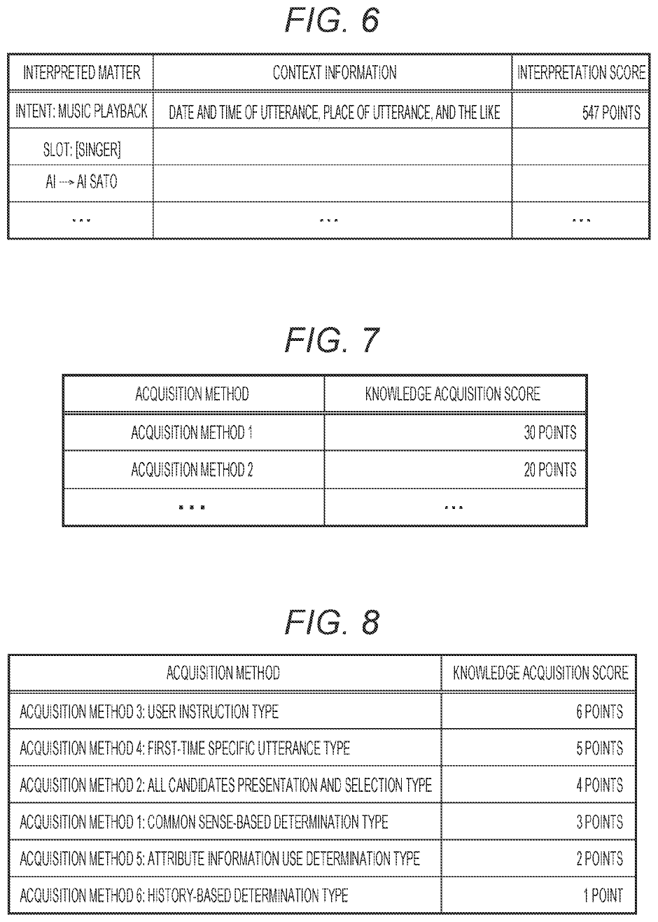

FIG. 6 schematically shows the configuration of the interpretation knowledge database in which multiple pieces of interpretation knowledge are stored. A single piece of interpretation knowledge includes an interpreted matter, context information, and an interpretation score. The interpreted matter relates to an intent and a slot. The interpreted matter is to be applied to the context information. The interpretation score indicates (or quantifies) a degree of priority at which the interpreted matter is to be applied to the context information. However, abstraction processing (to be described later) is performed on the context information. The interpreted matter includes “link knowledge” that links an abbreviated word or an abbreviated name to its original long name. The context information is information regarding circumstances other than a spoken voice at the time of a user's utterance, such as the time of utterance and a person (person nearby) who was near the user at the time of utterance. In addition, the context information may also include the place of utterance and various types of environmental information at the time of utterance.

Furthermore, a knowledge acquisition score table is prepared so as to assign the interpretation score to the interpretation knowledge. FIG. 7 schematically shows the configuration of the knowledge acquisition score table. The knowledge acquisition score table shown in the drawing is a quick reference table of respective knowledge acquisition scores assigned to methods of acquiring interpretation knowledge. When interpretation knowledge including a certain interpreted matter and context information is acquired, a knowledge acquisition score corresponding to an acquisition method used at that time is acquired from the knowledge acquisition score table, and is sequentially added to the interpretation score of corresponding entry in the interpretation knowledge database. For example, when interpretation knowledge of the intent “music playback” is acquired by an acquisition method 1 with specific context information (the date and time of utterance, the place of utterance, and the like), 30 points are added to the interpretation score of the interpretation knowledge.

When there is user feedback:

When there is feedback from the user on the response made by the information processing apparatus 100, the feedback is collected by the user feedback collection function 207 (S502). Then, the utterance intention understanding function 202 performs user feedback reflection processing (S503), and modifies stored contents of the interpretation knowledge database as appropriate.

There are various ways of expression when the user gives feedback on the response from the voice agent. However, the user feedback can be roughly classified into either positive or negative feedback.

When there is positive feedback from the user, it can be presumed that the intention of the user's utterance has been correctly interpreted. Therefore, as the user feedback reflection processing at this time, the interpretation score of corresponding interpretation knowledge in the interpretation knowledge database is increased by a predetermined value. Furthermore, it can be presumed that an acquisition method used for acquiring the interpretation knowledge was also correct. Thus, a corresponding knowledge acquisition score in the knowledge acquisition score table is also increased by a predetermined value.

Meanwhile, when there is negative feedback from the user, it can be presumed that the intention of the user's utterance has not been correctly interpreted. Therefore, as the user feedback reflection processing at this time, the interpretation score of the corresponding interpretation knowledge in the interpretation knowledge database is reduced by a predetermined value. Furthermore, it can also be presumed that the acquisition method used for acquiring the interpretation knowledge was not correct. Thus, the corresponding knowledge acquisition score in the knowledge acquisition score table is also reduced by a predetermined value.

When interpreting the user's utterance:

When the user's utterance is input from the microphone 113, text data (utterance text) subjected to voice recognition by the voice recognition function 201 are passed to the utterance intention understanding function 202. When the utterance text is input and the user's utterance is interpreted, the utterance intention understanding function 202 first generates an intention structure including an intent and a slot (S504). Then, it is checked whether there are multiple candidates for at least one of the intent or the slot (S505).

When the intention of the utterance is interpreted and only a single intent and a single slot are generated (No in S505), the utterance intention understanding function 202 outputs the single intent and the single slot as the result of understanding the intention. Thereafter, the application/service execution function 203 executes an application or service that matches the result of understanding the intention (S508).

Meanwhile, in a case where there are multiple candidates for at least one of the intent or the slot (Yes in S505), context matching processing is performed in which the current context acquired by the context acquisition function 206 is compared with the context information of each piece of interpretation knowledge in the interpretation knowledge database (S506).

Then, a single intent and a single slot are output as the result of understanding the intention by use of interpretation knowledge that matches the current context (or interpretation knowledge the context of which shows a similarity exceeding a predetermined threshold to the current context) (Yes in S507). Furthermore, in a case where there are multiple pieces of interpretation knowledge that match the context information at the time of the user's utterance, a piece of interpretation knowledge with the highest interpretation score is selected and the result of understanding the intention is output. Thereafter, the application/service execution function 203 executes an application or service that matches the result of understanding the intention (S508).

The context information has a hierarchical structure. Therefore, the matching of context information is performed at appropriate hierarchical levels in view of the hierarchical structure, in the context matching processing of S506. In the present embodiment, the context information is abstracted so as to perform the matching of context information at appropriate hierarchical levels. Specifically, the context information acquired by the context acquisition function 206 is temporarily stored in a log database, and subjected to abstraction processing (S509). Then, the context matching processing is performed by use of the result of abstraction. However, details of the abstraction processing of context information will be described later.

Note that in the initial state of the information processing apparatus 100 or at the time of starting the service, the interpretation knowledge database is basically empty of stored interpretation knowledge. In such a state, when there are multiple candidates for at least one of the intent or the slot at the time of interpreting the user's utterance, a cold start problem occurs in which it is not possible to converge to a single understanding of intention. Therefore, a general-purpose interpretation knowledge database constructed by the information processing apparatus 100 installed in any other home may be used as an initial interpretation knowledge database. In addition, if the interpretation knowledge score of each piece of interpretation knowledge in the initial interpretation knowledge database is reduced to a tenth of an original value, interpretation scores can relatively easily change in the user feedback reflection processing when use of the initial interpretation knowledge database is started. As a result, the tendency peculiar to that process will be expressed more strongly.

Next, the following describes further details of each behavior to be exhibited “at the time of acquiring interpretation knowledge”, “at the time of collecting user feedback”, and “at the time of interpretation” in the utterance intention understanding function shown in FIG. 5.

Behavior to be exhibited at the time of acquiring interpretation knowledge:

When interpretation knowledge is acquired, the utterance intention understanding function 202 performs processing for storing the interpretation knowledge in the interpretation knowledge database as shown in FIG. 6, in association with the interpreted matter, context information to which the interpreted matter is to be applied, and an interpretation score indicating a degree of priority at which the interpreted matter is to be applied to the context information. The interpretation knowledge database stores interpreted matters such as intents and slots, context information such as the date and time of the user's utterance and the place of the user's utterance at the time of interpretation, and interpretation scores to which the interpreted matters are to be applied.

The interpreted matter acquired as the interpretation knowledge may be an intent of utterance intention or a slot of utterance intention.

In a case where the interpreted matter acquired as the interpretation knowledge is an intent, information as to which intent is to be used for interpretation is acquired as interpretation knowledge. For example, in response to the utterance “Play xxx”, the following three types of intents are acquired as interpretation knowledge: “MUSIC_PLAY (music playback)”, “MOVIE_PLAY (movie playback)”, and “TV_PLAY (TV program playback)”.

Furthermore, in a case where the interpreted matter acquired as the interpretation knowledge is a slot, information as to which slot is to be used for interpretation is acquired as interpretation knowledge. For example, when the intent is interpreted as “music playback”, three types of interpretation knowledge “Ai Sato”, “Ai Yamada”, and “Ai Tanaka” are acquired for the slot “Ai”, and interpretation scores are assigned as follows.

Ai Sato: 127 points, Ai Yamada: 43 points, Ai Tanaka: 19 points

Furthermore, when interpretation knowledge of the intent or slot is acquired as described above, the interpretation knowledge is associated with information on a situation in which the interpretation knowledge is to be applied, that is, context information. Context information such as the date and time of the user's utterance and the place of user's utterance at the time of acquisition of the interpreted matter can be acquired by the context acquisition function. As described with reference to FIG. 3, the context information has a hierarchical structure. In view of the hierarchical structure, the context information is abstracted so as to perform the matching of context information at appropriate hierarchical levels. Then, the context matching processing is performed by use of the result of abstraction. However, details of the abstraction processing of context information will be described later.

The interpretation score is a value indicating a degree of priority at which the interpreted matter is to be applied. For example, assume that, in a certain context, there are three ways of interpreting the slot “Ai” as follows: “Ai Sato”, “Ai Yamada”, and “Ai Tanaka”, which are assigned interpretation scores of 127 points, 43 points, and 19 points, respectively. In such a case, “Ai Sato” with the highest score is preferentially applied. In this case, an interpreted matter that links “Ai” to “Ai Sato” (“Ai”→“Ai Sato”) is acquired as interpretation knowledge (link knowledge).

The utterance intention understanding function 202 updates the interpretation knowledge database every time interpretation knowledge is acquired.

There are various methods of acquiring interpretation knowledge. The interpretation score of interpretation knowledge is added according to an acquisition method for acquiring the interpretation knowledge when the interpretation knowledge database is updated. For example, in the case of an acquisition method with high reliability (interpretation knowledge acquired by the method is reliable), a large value is added to the interpretation score. Meanwhile, in the case of an acquisition method with low reliability (the reliability of interpretation knowledge acquired by the method is low), a small value is added to the interpretation score. Six acquisition methods 1 to 6 will be described below.

### (1) Acquisition Method 1: Common Sense-Based Determination Type

This is a method of determining the most appropriate one of multiple candidates for an intent or slot on the basis of common sense among people. For example, in order to show whom the name “Ai” generally refers to as a common recognition among people, popularity rankings are made on the basis of various pieces of information on the Internet. Thus, the most appropriate one of multiple candidates for an intent or slot is determined on the basis of the ranking results.

Furthermore, the degree of popularity of each candidate for the intent or slot is periodically measured, and the interpretation knowledge database is updated on the basis of the result.

Interpretation knowledge to be acquired by the acquisition method 1 is common to all people. Meanwhile, such interpretation knowledge may lead to misinterpretation for a user who is quite different in preference from other people. For example, when saying “Ai”, most people mean “Ai Sato”. Meanwhile, in a case where only a single user recommends “Ai Tanaka”, interpretation knowledge for such a special user cannot be obtained by the acquisition method 1.

### (2) Acquisition Method 2: All Candidates Presentation and Selection Type

This is a method of presenting a plurality of candidates for an intent or slot to allow a user to select from among the candidates. For example, as the interpretation of the slot “Ai”, three types of interpretation “Ai Sato”, “Ai Yamada”, and “Ai Tanaka” are presented to the user for selection. For example, even if most people interpret the word “Ai” as “Ai Sato” in relation to the intent of music playback, an interpreted matter that links “Ai” to “Ai Tanaka” (“Ai”→“Ai Tanaka”) is acquired as interpretation knowledge and stored in the interpretation knowledge database when a user selects “Ai Tanaka”. Then, when the user says, “Play the music of Ai” next time and thereafter, “Ai Tanaka” is selected on the basis of the link knowledge and the slot “Ai” generated from the utterance, and the music of Ai Tanaka is played.

According to the acquisition method 2, it is possible to reliably construct the interpretation knowledge database that can also meet the need of a user who thinks in quite a different way from other people. However, there is a problem that the user is required to spend time and effort.

### (3) Acquisition Method 3: User Instruction Type

This is a method of acquiring interpretation knowledge on the basis of details of a user's instruction. For example, when a user gives an instruction by saying “When I say Ai, I mean Ai Tanaka”, interpretation knowledge (link knowledge) that links “Ai” to “Ai Tanaka” (“Ai”→“Ai Tanaka”) is stored in the interpretation knowledge database. Then, when the user says, “Play the music of Ai” next time and thereafter, “Ai Tanaka” is selected as a slot, and the music of Ai Tanaka is played.

The acquisition method 3, which is based on a user's direct instruction, is a reliable method. However, there is a problem that the user is required to spend time and effort constructing the interpretation knowledge database.

### (4) Acquisition Method 4: First-Time Specific Utterance Type

When a user says (first time), “Play the music of Ai Tanaka”, the link knowledge “Ai”→“Ai Tanaka” is stored in the interpretation knowledge database. Then, when the user says, “Play the music of Ai” next time and thereafter, “Ai Tanaka” is selected as a slot, and the music of Ai Tanaka is played.

Even in conversations between people, there are cases where people avoid ambiguous wording such as the abbreviated name “Ai” and say, “Play the music of Ai Tanaka” the first time, and say, “Play the music of Ai” the second time and thereafter by using the abbreviated name if it is considered that there is a possibility that misunderstanding may be caused since there are multiple candidates for an intent or slot. The acquisition method 4 is based on such common practice in conversation of people.

It is easy for users to accept the method because the users just need to speak in the same way as everyday conversation. However, not all users avoid ambiguous wording and use specific wording the first time. There is a problem that this acquisition method requires users who have no habit of avoiding ambiguous wording the first time to pay attention, and that in the case of users paying no attention, it is difficult to store interpretation knowledge.

### (5) Acquisition Method 5: Attribute Information Use Determination Type

This is a method of determining the most appropriate one of multiple candidates for an intent or slot by using attribute information on a user. For example, the utterance “Tell me about the weather in Osaki” can be interpreted in the following three ways because there are several places named “Osaki” in Japan.

Osaki Town in Kagoshima

Osaki City in Miyagi Prefecture

Osaki in Shinagawa-ku, Tokyo

In such a case, “Osaki” that is the closest to the latitude and longitude of the user's current location as the attribute information is determined, and the corresponding weather is presented.

### (6) Acquisition Method 6: History-Based Determination Type

This is a method of determining the most appropriate one of multiple candidates for an intent or slot by using history information on a user. For example, when the user says, “Play the music of Ai”, the slot “Ai” for the intent “music playback” has multiple candidates “Ai Sato”, “Ai Yamada”, and “Ai Tanaka”. Thus, this utterance is ambiguous. However, if the user has history information that the music of Ai Tanaka is frequently played, the music of Ai Tanaka is played.

For example, in a case where the information processing apparatus 100 is an information terminal such as a smartphone or a tablet terminal, the history information on the user can be acquired to be used for the determination described above, on the basis of application data (schedule book, playlist, and the like) used by the user.

According to the acquisition method 6, the user is not required to spend time and effort acquiring history information. However, it is considered difficult to make a highly accurate determination.

As described above, when interpretation knowledge is acquired and the interpretation knowledge database is updated, a knowledge acquisition score corresponding to the acquisition method is added to the interpretation score of the interpretation knowledge. For example, a high knowledge acquisition score is assigned to an acquisition method with high reliability (interpretation knowledge acquired by the method is reliable), and a low knowledge acquisition score is assigned to an acquisition method with low reliability (the reliability of interpretation knowledge acquired by the method is low). FIG. 8 shows examples of knowledge acquisition scores assigned to the acquisition methods 1 to 6 described above.

For example, when a user says, “Play the music of Ai”, the information processing apparatus 100 presents the user with three candidates of “Ai Sato”, “Ai Yamada”, and “Ai Tanaka”. If the user selects “Ai Tanaka”, a knowledge acquisition score of 4 points is added to the interpretation score of the link knowledge “Ai”→“Ai Tanaka”. This is because this interpretation knowledge has been acquired by the acquisition method 2 (all candidates presentation and selection type).

Behavior to be exhibited at the time of collecting user feedback:

When there is feedback from the user on the response made by the information processing apparatus 100, the user feedback is collected by the user feedback collection function 207, and the utterance intention understanding function 202 appropriately modifies the stored contents of the interpretation knowledge database accordingly.

There are various ways of expression when the user gives feedback on the response from the voice agent. However, the user feedback can be roughly classified into either positive or negative feedback.

Assume that the user utters positive words such as “That's it” or “Thank you”, the user reads the response result received from the voice agent, or the user starts using the application, immediately after the voice agent returns a response. In such cases, it is considered that there has been positive feedback from the user.

When there is positive feedback from the user, it can be presumed that the intention of the user's utterance has been correctly interpreted. Therefore, as the user feedback reflection processing at this time, the interpretation score of corresponding interpretation knowledge in the interpretation knowledge database is increased by a predetermined value.

Meanwhile, assume that the user utters negative words such as “No” or “No, it is xxx”, the user does not read the response result received from the voice agent, or the user does not use the application, immediately after the voice agent returns a response. In such cases, it is considered that there has been negative feedback from the user.

When there is negative feedback from the user, it can be presumed that the intention of the user's utterance has not been correctly interpreted. Therefore, as the user feedback reflection processing at this time, the interpretation score of the corresponding interpretation knowledge in the interpretation knowledge database is reduced by a predetermined value.

Furthermore, when there is feedback from the user, the knowledge acquisition score in the knowledge acquisition score table is also updated according to whether the feedback is positive or negative.

For example, link knowledge acquired by the acquisition method 3 of user instruction type can be considered strong. When the user gives an instruction by saying “When I say Ai, I mean Ai Tanaka”, link knowledge that links “Ai” to “Ai Tanaka” (“Ai” →“Ai Tanaka”) is stored in the interpretation knowledge database and in addition, an interpretation score of 6 points is added. However, the link knowledge “Ai”→“Ai Tanaka” is not always strong in the future, and some users may desire the acquisition method 2 of all candidates presentation and selection type to be stronger (desire that one selected the previous time be also selected this time).

Therefore, when there is positive feedback from the user, it can be presumed that an acquisition method used for acquiring the interpretation knowledge was also correct. Thus, a corresponding knowledge acquisition score in the knowledge acquisition score table is also increased by a predetermined value. In contrast, when there is negative feedback from the user, it can also be presumed that the acquisition method used for acquiring the interpretation knowledge was not correct. Thus, the corresponding knowledge acquisition score in the knowledge acquisition score table is also reduced by a predetermined value.

As a result of the above, interpretation knowledge more useful to the user becomes stronger, and an acquisition method more useful to the user also becomes stronger in view of the feedback from the user.

Behavior to be exhibited at the time of interpretation:

When the user's utterance is input from the microphone 113, text data (utterance text) subjected to voice recognition by the voice recognition function 201 are passed to the utterance intention understanding function 202. When the utterance text is input and the user's utterance is interpreted, the utterance intention understanding function 202 first generates an intention structure including an intent and a slot. Then, when there are multiple candidates for at least one of the intent or the slot, context matching processing is performed in which the current context acquired by the context acquisition function 206 is compared with the context information of each piece of interpretation knowledge in the interpretation knowledge database. Thus, the most effective interpretation knowledge is applied to execute an application or service that matches the result of understanding intention.

Here, abstraction processing is performed on context when the context matching is performed.

For example, a person nearby (a person who was near the user at the time of utterance) is defined by the following hierarchical structure.

[Math. 1]

FAMILY

PARENTS

FATHER
MOTHER

CHILDREN

SON
DAUGHTER

FRIEND
COLLEAGUE
. . .

Then, assume a situation where certain interpretation knowledge is applied to each terminal node in the hierarchical structure as shown below.

### [Math. 2]

### APPLIED (THRESHOLD IS EXCEEDED) WHEN SON UTTERS AND FATHER IS NEAR SON

### APPLIED (THRESHOLD IS EXCEEDED) WHEN SON UTTERS AND MOTHER IS NEAR SON

In such a situation, interpretation knowledge for which all elements in a certain layer of context information exceed a threshold is applied to the next layer up, as shown below. This is called “abstraction” of context information.

### [Math. 3]

### TO BE APPLIED WHEN SON UTTERS AND PARENT IS NEAR SON

The abstraction will be described in more detail. Assume that context information is defined as follows.

[Math. 4]

TIME OF UTTERANCE [WHEN]

SEASON

MONTH

DAY OF WEEK
TIME ZONE
. . .

PERSON NEARBY (PERSON WHO WAS NEAR USER AT TIME OF
UTTERANCE)
[WHO]

FAMILY

PARENTS

FATHER
MOTHER

CHILDREN

SON
DAUGHTER

FRIEND
COLLEAGUE
. . .

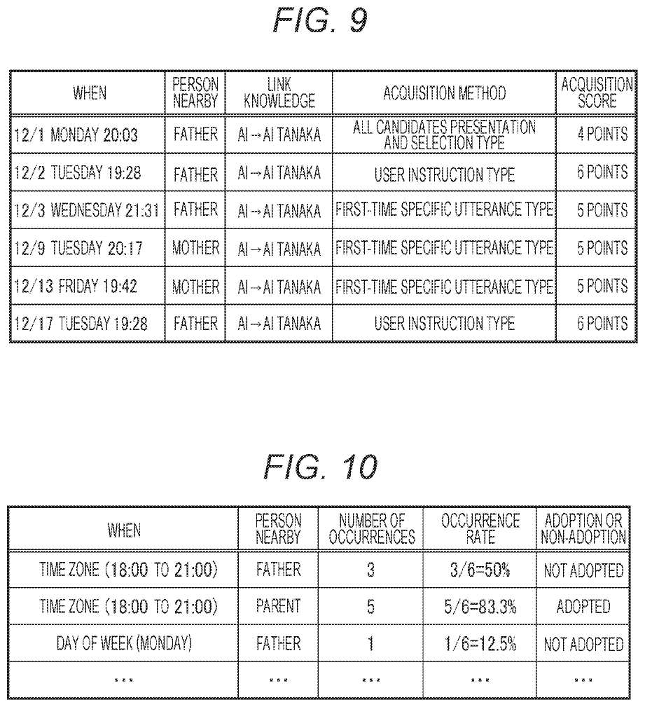

Assume that as a result of the context information acquisition processing performed by the context collection function 206, for example, knowledge as shown in FIG. 9 is acquired in the log database. Then, an interpreted matter with acquisition scores the total of which has reached a predetermined threshold is acquired as interpretation knowledge and stored in the interpretation knowledge database. Here, assuming that the threshold of the acquisition score is 30 points, acquisition scores for the link interpretation “Ai” →“Ai Tanaka” have totaled 31 points at 19:28 on Tuesday, 12/17, and have reached the threshold in the example shown in FIG. 9. At this time, there are several possibilities of abstracting multiple pieces of context information collected when the link interpretation “Ai”→“Ai Tanaka” is acquired, as shown below.

### [Math. 5]

### IS IT REGISTERED AS LINK KNOWLEDGE TO BE APPLIED ON FOLLOWING CONDITIONS: “WHEN=TIME ZONE (18:00˜20:00)” AND “PERSON NEARBY=FATHER”?

### IS IT REGISTERED AS LINK KNOWLEDGE TO BE APPLIED ON FOLLOWING CONDITIONS: “WHEN=DAY OF WEEK (TUESDAY)” AND “PERSON NEARBY=FATHER”?

### IS IT REGISTERED AS LINK KNOWLEDGE TO BE APPLIED ON FOLLOWING CONDITIONS: “WHEN=DAY OF WEEK (TUESDAY)” AND “PERSON NEARBY=PARENT”?

While there are multiple possibilities of abstraction in this way, in a case where, for example, an occurrence rate of the link interpretation “Ai”→“Ai Tanaka” in a layer reaches or exceeds a predetermined threshold (for example, 80%), the layer is adopted to abstract context information. The occurrence rate refers to the proportion of the number of cases where the link interpretation “Ai”→“Ai Tanaka” has occurred in the layer to the total number of cases where the link interpretation “Ai”→“Ai Tanaka” has occurred.

For example, regarding the time of utterance “when”, assuming that a time zone is defined such that a day is divided into eight time zones of three hours each, the case of “Ai”→“Ai Tanaka” occurred five times in the time zone of 18:00 to 21:00, and once in the time zone of 21:00 to 24:00. Meanwhile, the case of “Ai”→“Ai Tanaka” did not occur in any of the other six time zones. Since an occurrence rate corresponding to the time zone of 18:00 to 21:00 is 5/6=83.3% (>80%), the time zone of 18:00 to 21:00 is adopted to perform abstraction in the layer of time zones.

In addition, seven types of days of the week are defined. The case of “Ai”→“Ai Tanaka” occurred once on Monday, three times on Tuesday, once on Wednesday, and once on Friday. Meanwhile, the case of “Ai”→“Ai Tanaka” did not occur on Thursday, Saturday, and Sunday. The number of occurrences on Tuesday is the largest. However, since even an occurrence rate corresponding to Tuesday is 3/6=50% (<80%), abstraction is not performed in the layer of days of the week.

Furthermore, regarding a person nearby (a person who was near a speaker at the time of utterance) “who”, assuming that three family members, that is, the father, mother, and brother of the speaker were near the speaker. Referring to the number of occurrences in the layer of each family member, the case of “Ai” →“Ai Tanaka” occurred four times for the father, and twice for the mother. An occurrence rate corresponding to the layer of the father is 4/6=66.7% (<805). Therefore, abstraction is not performed in individual layers. Referring to the occurrence rate of the case of “Ai”→“Ai Tanaka” in the layer of parents or children, an occurrence rate in the layer of parents is 6/6=100% (>80%), so that abstraction in the layer of parents is adopted.

Moreover, it is necessary to consider whether the context information can be abstracted, for all combinations of the time of utterance “when” and a person nearby (a person who was near the user at the time of utterance) “who”. FIG. 10 shows the number of occurrences and the occurrence rate of the case of “Ai”→“Ai Tanaka” for each combination of the time of utterance “when” and a person nearby (a person who was near the user at the time of utterance) “who”. The occurrence rate of the case of “Ai”→“Ai Tanaka” is 3/6=50% (<80%) for a combination of “when=time zone (18:00 to 21:00) and person nearby=father”, so that abstraction with this combination is not adopted. Furthermore, the occurrence rate of the case of “Ai”→“Ai Tanaka” is 5/6=83.3% (>80%) for a combination of “when=time zone (18:00 to 21:00) and person nearby=parent”, so that abstraction with this combination is adopted. In addition, the occurrence rate of the case of “Ai”→“Ai Tanaka” is 1/6=12.5% (<80%) for a combination of “when=day of the week (Monday) and person nearby=father”, so that abstraction with this combination is not adopted.

Therefore, context information to be abstracted and adopted for the link knowledge “Ai”→“Ai Tanaka” is as follows.

### [Math. 6]

### COMBINATION OF “WHEN=TIME ZONE (18:00˜21:00)” AND “PERSON NEARBY=PARENT”

The above is an example of acquiring interpretation knowledge of a single household. In addition, if pieces of interpretation knowledge acquired from a plurality of households are collected and merged, context information can be broadly abstracted as follows.

### [Math. 7]

### CERTAIN KNOWLEDGE IS

APPLIED (THRESHOLD IS EXCEEDED) WHEN CHILD UTTERS AND PARENT IS NEAR CHILD

As a result of using interpretation knowledge merged in such a way as to broadly abstract context information as described above, utterance is interpreted with a certain degree of accuracy by use of general-purpose interpretation knowledge even in a home where the information processing apparatus 100 is purchased and the voice agent function is used for the first time, so that an appropriate response is returned from the voice agent. Therefore, the cold start problem is solved and user convenience is ensured. Furthermore, if the interpretation knowledge score of each piece of interpretation knowledge in the initial interpretation knowledge database is reduced to a tenth of an original value, interpretation scores can relatively easily change in the user feedback reflection processing when use of the initial interpretation knowledge database is started. As a result, the voice agent can quickly fit individual users.

In addition, if attributes such as gender are added to the hierarchical structure of the person nearby in the context information as described below, it is also possible to raise the terminal node to an abstract level such as male or female.

Math. 8

PERSON NEARBY (PERSON WHO WAS NEAR USER AT TIME OF
UTTERANCE)
[WHO]

FAMILY

PARENTS

| | |
|---|---|
| FATHER | MALE |
| MOTHER | FEMALE |

CHILDREN

| | |
|---|---|
| SON | MALE |
| DAUGHTER | FEMALE |

| | |
|---|---|
| FRIEND | MALE |
| FRIEND | FEMALE |
| COLLEAGUE | MALE |
| COLLEAGUE | FEMALE |

. . .

Finally, an example of interpreting the intention of a user's utterance by the utterance intention understanding function according to the present embodiment will be described.

### Example 1: Case where the Content of Utterance is Identical but Context is Different Only in Mood

In a case where all family members are at home on Sunday night, and the utterance “Play Ai” is made by use of a home agent at the house, “MUSIC_PLAY” and “MOVIE_PLAY” are possible interpreted matters for an intent.

When the mood seems to be busy, “MUSIC_PLAY” is selected on the basis of context information since background music is desired to be played. Furthermore, when the mood is relaxed, “MOVIE_PLAY” is selected on the basis of context information since the family members feel like watching a movie.

### Example 2: Case where the Content of Utterance is Identical but Context is Different Only in Person Nearby

In a case where all family members are at home on Sunday night, and the utterance “Play” is made by use of a home agent at the house, “MUSIC_PLAY” and “MOVIE_PLAY” are possible interpreted matters for an intent.

When the mom is there, “MUSIC_PLAY” is selected because the mom does not want children to watch animated cartoons. Furthermore, when the mom is not there, “MOVIE_PLAY” is selected because the dad is indulgent to the children and allows the children to watch animated cartoons.

### Example 3: Case where a User is Moving

There are two places named “Shinjuku”, that is, “Shinjuku-ku, Tokyo” and “Shinjuku, Chuo-ku, Chiba City”. Then, assume that a user lives in Shinjuku in Chiba City, and works in Shinjuku, Tokyo.

In a case where the user says, “What is the weather like in Shinjuku?” in the morning at home (Shinjuku in Chiba City), the weather in Shinjuku, Tokyo is selected since the user is concerned about whether it will rain when the user arrives at the user's workplace.

Furthermore, in a case where the user says, “What is the weather like in Shinjuku?” at the workplace (Shinjuku in Tokyo) at noon, the weather in Shinjuku in Chiba City is selected since the user is concerned about whether it will rain when the user leaves for home and arrives at the nearest station to the user's home (Shinjuku in Chiba City).

The behavior patterns of the user on weekdays are substantially the same. It is appropriate to respond to the user by interpreting the place as Shinjuku in Tokyo on weekday mornings and interpreting the place as Shinjuku in Chiba City at noon on weekdays.

### INDUSTRIAL APPLICABILITY

The technology disclosed in the present specification has been described above in detail with reference to the specific embodiment. However, it is obvious that a person skilled in the art can make modifications and substitutions of the embodiment without departing from the gist of the technology disclosed in the present specification.

The technology disclosed in the present specification can be applied not only to the case of installing devices dedicated to voice agents, but also to the case of installing information terminals, such as smartphones and tablet terminals, and various devices such as information home appliances and IoT devices in which agent applications reside. Furthermore, at least some of the functions of the technology disclosed in the present specification can also be provided and executed in collaboration with agent services built on the cloud.

In short, the technology disclosed in the present specification has been described in the form of exemplification, and the contents described in the present specification should not be interpreted restrictively. In order to judge the gist of the technology disclosed in the present specification, the claims should be taken into consideration.

Note that the technology disclosed in the present specification may also adopt the following configurations.

(1) An information processing apparatus including:

a generation unit that generates an utterance intention from a user's utterance, the utterance intention including an intent and a slot; and

a determination unit that determines a most appropriate interpretation among a plurality of candidates on the basis of context information at a time of the user's utterance in a case where the generation unit obtains the plurality of candidates for at least one of the intent or the slot.

(1-1) The information processing apparatus according to (1) above, further including:

a collection unit that acquires the context information at the time of the user's utterance.

(1-2) The information processing apparatus according to (1) above, further including:

a response unit that responds on the basis of the utterance intention of the user.

(1-3) The information processing apparatus according to (1) above, in which

the response unit responds to the user by voice.

(1-4) The information processing apparatus according to (1-2) above, further including:

a collection unit that collects feedback information from the user on the response from the response unit.

(2) The information processing apparatus according to (1) above, in which

the intent is an application or a service, execution of which is requested by the user's utterance, and

the slot is attached information to be used when the application or the service is executed.

(3) The information processing apparatus according to (1) or (2) above, in which

the context information is information regarding circumstances other than a spoken voice at the time of the user's utterance.

(3-1) The information processing apparatus according to (3) above, in which

the context information includes at least one of a time of utterance, a place of utterance, a person nearby, a device used for utterance, a mood, or an utterance domain.

(4) The information processing apparatus according to any one of (1) to (3) above, in which

the determination unit determines the most appropriate interpretation among the plurality of candidates also on the basis of feedback information from the user on a response based on the utterance intention.

(5) The information processing apparatus according to any one of (1) to (4) above, further including:

a storage unit that stores, as interpretation knowledge, an interpreted matter regarding the intent or the slot and context information to which the interpreted matter is to be applied,

in which the determination unit determines an interpretation of the utterance intention of the user on the basis of interpretation knowledge that matches the context information at the time of the user's utterance.

(6) The information processing apparatus according to (5) above, in which

the storage unit further stores an interpretation score indicating a degree of priority at which the interpreted matter is to be applied to the context information, and

the determination unit selects interpretation knowledge having a high interpretation score from among the interpretation knowledge that matches the context information at the time of the user's utterance.

(7) The information processing apparatus according to (6) above, in which

the interpretation score is determined on the basis of a method used for acquiring the interpretation knowledge.

(8) The information processing apparatus according to (6) or (7) above, in which

on the basis of feedback information from the user on a response based on interpretation knowledge determined by the determination unit, the interpretation score of the corresponding interpretation knowledge is updated.

(9) The information processing apparatus according to (8) above, in which

in a case where there is positive feedback from the user, the interpretation score of the corresponding interpretation knowledge is increased.

(10) The information processing apparatus according to (8) or (9) above, in which

in a case where there is negative feedback from the user, the interpretation score of the corresponding interpretation knowledge is reduced.

(11) The information processing apparatus according to any one of (1) to (10) above, in which

the context information has a hierarchical structure, and

the determination unit performs the determination on the basis of comparison of the context information between appropriate hierarchical levels in view of the hierarchical structure.

(12) The information processing apparatus according to (11) above, in which

a layer in which an occurrence rate is equal to or greater than a predetermined threshold is adopted to abstract the context information to be applied to a certain interpreted matter, the occurrence rate being a proportion of the number of cases where the certain interpreted matter has occurred in the layer to the total number of cases where the certain interpreted matter has occurred.

(13) An information processing method including:

a generation step of generating an utterance intention from a user's utterance, the utterance intention including an intent and a slot; and

a determination step of determining a most appropriate interpretation among a plurality of candidates on the basis of context information at a time of the user's utterance in a case where the plurality of candidates is obtained for at least one of the intent or the slot in the generation step.

### REFERENCE SIGNS LIST

100 Information processing apparatus
101 Control unit
101A CPU
101B ROM
101C RAM
102 Information access unit
103 Operation unit interface
104 Communication interface
105 Voice input interface
106 Video input interface
107 Voice output interface
108 Video output interface
111 Information recording device
112 Operation device
113 Microphone
114 Camera
115 Speaker
116 Display unit

1. An information processing apparatus comprising:
a generation unit that generates an utterance intention from a user's utterance, the utterance intention including an intent and a slot; and
a determination unit that determines a most appropriate interpretation among a plurality of candidates on a basis of context information at a time of the user's utterance in a case where the generation unit obtains the plurality of candidates for at least one of the intent or the slot.

2. The information processing apparatus according to claim 1, wherein
the intent is an application or a service, execution of which is requested by the user's utterance, and
the slot is attached information to be used when the application or the service is executed.

3. The information processing apparatus according to claim 1, wherein
the context information is information regarding circumstances other than a spoken voice at the time of the user's utterance.

4. The information processing apparatus according to claim 1, wherein
the determination unit determines the most appropriate interpretation among the plurality of candidates also on a basis of feedback information from the user on a response based on the utterance intention.

5. The information processing apparatus according to claim 1, further comprising:
a storage unit that stores, as interpretation knowledge, an interpreted matter regarding the intent or the slot and context information to which the interpreted matter is to be applied,
wherein the determination unit determines an interpretation of the utterance intention of the user on a basis of interpretation knowledge that matches the context information at the time of the user's utterance.

6. The information processing apparatus according to claim 5, wherein
the storage unit further stores an interpretation score indicating a degree of priority at which the interpreted matter is to be applied to the context information, and
the determination unit selects interpretation knowledge having a high interpretation score from among the interpretation knowledge that matches the context information at the time of the user's utterance.

7. The information processing apparatus according to claim 6, wherein
the interpretation score is determined on a basis of a method used for acquiring the interpretation knowledge.

8. The information processing apparatus according to claim 6, wherein
on a basis of feedback information from the user on a response based on interpretation knowledge determined by the determination unit, the interpretation score of the corresponding interpretation knowledge is updated.

9. The information processing apparatus according to claim 8, wherein
in a case where there is positive feedback from the user, the interpretation score of the corresponding interpretation knowledge is increased.

10. The information processing apparatus according to claim 8, wherein
in a case where there is negative feedback from the user, the interpretation score of the corresponding interpretation knowledge is reduced.

11. The information processing apparatus according to claim 1, wherein
the context information has a hierarchical structure, and
the determination unit performs the determination on a basis of comparison of the context information between appropriate hierarchical levels in view of the hierarchical structure.

12. The information processing apparatus according to claim 11, wherein
a layer in which an occurrence rate is equal to or greater than a predetermined threshold is adopted to abstract the context information, the occurrence rate being a proportion of a number of cases where a certain interpreted matter has occurred in the layer to a total number of cases where the certain interpreted matter has occurred.

13. An information processing method comprising:
a generation step of generating an utterance intention from a user's utterance, the utterance intention including an intent and a slot; and
a determination step of determining a most appropriate interpretation among a plurality of candidates on a basis of context information at a time of the user's utterance in a case where the plurality of candidates is obtained for at least one of the intent or the slot in the generation step.
